(19) United States
(12) Patent Application Publication
(10) Pub. No.: US 2023/0214893 A1
(43) Pub. Date: Jul. 6, 2023

(54) IMPROVED SYSTEM AND METHOD FOR AUTOMATING BUSINESS ACCOUNTING

(71) Applicant: INBUILD INC., WILMINGTON, DE (US)

(72) Inventors: Ty Sharp, Aspen, CO (US); Ian Sharp, Aspen, CO (US)

(73) Assignee: INBUILD INC., WILMINGTON, DE (US)

(21) Appl. No.: 18/092,490

(22) Filed: Jan. 3, 2023

Related U.S. Application Data
(60) Provisional application No. 63/295,584, filed on Dec. 31, 2021.

(51) Int. Cl. G06Q 30/04; G06F 16/178; G06F 3/0484; G06V 30/19

(52) U.S. Cl. CPC G06Q 30/04; G06F 16/1794; G06F 3/0484; G06V 30/19; G06F 3/0483

(57) ABSTRACT

A system including a database configured to store data characterizing a plurality of emails, a plurality of projects, a plurality of vendors, and a plurality of invoices. Each invoice of the plurality of invoices includes data characterizing a project of the plurality of projects, a vendor of the plurality of vendors, and a plurality of invoice data. The system also includes a computing system communicatively coupled to the database and including at least one processor. The at least one processor is configured to receive a file in a first format, convert the file into a second format, determine a first project, a first vendor, and a first plurality of invoice data based on data in the file, prepare a new invoice based on the first project, the first vendor, and the first plurality of invoice data determined, and provide the new invoice in a third format.

### BACKGROUND

This invention pertains to a system and method particularly designed to be used in business accounting, particularly in the field of construction management.

Traditionally, the process of receiving and preparing invoices, obtaining approvals, filing disputes, and entering invoices into various enterprise resource planning (ERP) tools is a tedious process. ERP tools are designed to manage and integrate a company's core business processes, such as financials, manufacturing, supply chain, project management, and human resources. Traditionally, however, there is no way to automatically receive an invoice into an ERP from an email. Traditionally, this process requires significant hours of human labor, and is extremely error prone.

### SUMMARY

In one aspect, a system for automating business accounting is provided. In an embodiment, the system can include a database configured to store data characterizing a plurality of projects, a plurality of vendors, and a plurality of invoices. In some embodiments, each invoice includes data characterizing a project of the plurality of projects, a vendor of the plurality of vendors, and a plurality of other invoice data. The system can also include a computing system communicatively coupled to the database and including a memory and at least one processor. The at least one processor can receive a file in a first format, and convert the file into a second format, to determine the data in the file. The processor can further determine a first project, a first vendor, and a first plurality of other invoice data based on data in the file in the second format, and prepare a new invoice based on the first project, the first vendor, and the first plurality of other invoice data determined. The processor can further be configured to provide the new invoice in a third format. In some embodiments, the third format is a format that is compatible with a specific ERP tool and/or the database.

In another embodiment, the processor can additionally determine a name for the new invoice based on the first project, the first vendor, and/or first plurality of other invoice data determined, and based on instructions stored on the memory. The processor can further transmit the file and the new invoice to the database.

In another embodiment, the system can further include a graphical user interface (GUI) communicatively coupled to the computing system and arranged to receive commands comprising a review command, an edit command, a validate command, an approve command, a dispute command, and/or a send command.

In another embodiment, the system can be arranged to receive, by the GUI, the dispute command; and send, by the at least one processor, the new invoice to at least one email address along with an optional dispute message responsive to the received dispute command.

In another embodiment, the file can be received as an attachment to an email message. In this embodiment, the first plurality of other invoice data further includes at least one requestor email address, and the at least one email address and the at least one requestor email address can be the same.

In another embodiment, the system can be arranged to receive, by the GUI, the approve command. In this embodiment, the processor can provide the new invoice to an enterprise resource planning tool coupled to the computing system in the third format responsive to the received approve command.

In another embodiment, the first plurality of other invoice data can further include a first digital fingerprint for the file in the first format, and the database can further include data characterizing a plurality of digital fingerprints for a plurality of files in the first format. In this embodiment, the at least one processor can be configured to compare the first digital fingerprint to the data characterizing the plurality of digital fingerprints stored the database. Further, the at least one processor can be configured to determine that the file is a duplicate based on the comparing, and discard the file.

In another embodiment, the at least one processor can further be configured to compare the first project, the first vendor, and/or first plurality of other invoice data to the data in stored the database.

In another embodiment, the at least one processor can be configured to compare the first project to the plurality of projects and/or the first vendor to the plurality of vendors. In this embodiment, the at least one processor can determine that the first project is not in the plurality of projects and/or that the first vendor is not in the plurality of vendors. Responsive to determining that the first project is not in the plurality of projects and/or that the first vendor is not in the plurality of vendors, the processor can be configured to create a new project in the plurality of projects based on the first project and/or a new vendor of the plurality of vendors based on the first vendor.

In another embodiment, the determining of the first project, the first vendor, and the first plurality of other invoice data can be done using optical character recognition. In another embodiment, the first format is any one of an image format, a document format, and a presentation format, and the second format is an image format, and the third format is a document format.

In another aspect, a method for automating business accounting is provided. In one embodiment, the method can include a step of receiving, by at least one processor of a computing system, a file in a first format. The method can further include a step of converting, by the at least one processor, the file into a second format to determine the data in the file. The method can further include determining, by the at least one processor, a first project, a first vendor, and a first plurality of other invoice data based on data in the file in the second format. The method can further include preparing, by the at least one processor, a new invoice based on the first project, the first vendor, and the first plurality of other invoice data determined. The method can further include providing, by the at least one processor, the new invoice in a third format.

In another embodiment, the method can include determining, by the at least one processor, a name for the new invoice based on the first plurality of other invoice data determined, and based on instructions stored on a memory of the computing system. In this embodiment, the method can also include transmitting, by the at least one processor, the file and the new invoice to a database. In this embodiment, the database can be configured to store data characterizing a plurality of emails, a plurality of projects, a plurality of vendors, and a plurality of invoices. In this embodiment, each invoice can include data characterizing a project of the plurality of projects, a vendor of the plurality of vendors, and a plurality of other invoice data.

In another embodiment, the method can include receiving, by the at least one processor, a dispute command from a graphical user interface (GUI) communicatively coupled to the computing system. The method can further include sending, by the at least one processor, the new invoice to at least one email address along with an optional dispute message responsive to receiving the dispute command.

In another embodiment, the file can be received as an attachment to an email message, and the first plurality of other invoice data can further include at least one requestor email address. In this embodiment, the at least one email address and the at least one requestor email address can be the same.

In another embodiment, the method can include receiving, by the at least one processor, an approve command from a graphical user interface (GUI) communicatively coupled to the computing system. In this embodiment, the method can further include providing, by the at least one processor, the new invoice to an enterprise resource planning tool coupled to the computing system responsive to receiving the approve command.

In another embodiment, the first plurality of other invoice data can further include a first digital fingerprint for the file in the first format, and the database further includes data characterizing a plurality of digital fingerprints for a plurality of files in the first format. In this embodiment, the method can further include comparing, by the at least one processor, the first digital fingerprint to the data characterizing the plurality of digital fingerprints stored the database. The method can also include determining, by the at least one processor, that the file is a duplicate based on the comparing, and discard the file.

In another embodiment, the method can include comparing, by the at least one processor, the first project, the first vendor, and/or first plurality of invoice data to the data in stored the database.

In another embodiment, the method can include comparing, by the at least one processor, the first project to the plurality of projects and/or the first vendor to the plurality of vendors. In this embodiment, the method can also include determining, by the at least one processor, that the first project is not in the plurality of projects and/or that the first vendor is not in the plurality of vendors. Responsive to determining that the first project is not in the plurality of projects and/or that the first vendor is not in the plurality of vendors, the method can further include creating, by the at least one processor, a new project in the plurality of projects based on the first project and/or a new vendor of the plurality of vendors based on the first vendor.

In another embodiment, the determining of the first project, the first vendor, and the first plurality of other invoice data is done using optical character recognition.

### DESCRIPTION OF DRAWINGS

These and other features will be more readily understood from the following detailed description taken in conjunction with the accompanying drawings, in which:

FIG. 1 illustrates an example of a process of converting a file into a new invoice and sending it to an ERP according to the system and methods described herein.

FIG. 2 is a block diagram of an example architecture of a computing system described herein.

FIG. 3 illustrates an example of a window of a graphical user interface (GUI) of the system described herein.

FIG. 4 illustrates an example of another window of a graphical user interface (GUI) of the system described herein, showing data determined by the at least one processor of the system.

FIG. 5 illustrates an example of another window of a graphical user interface (GUI) of the system described herein, showing a prepared a new invoice.

FIG. 6 illustrates an example of another window of a graphical user interface (GUI) of the system described herein, showing a prepared a new invoice received by a requestor to be approved an approver.

FIG. 7 illustrates an example of another window of a graphical user interface (GUI) of the system described herein, showing an approved invoice.

FIG. 8 illustrates an example of another window of a graphical user interface (GUI) of the system described herein, showing an assigned billing period for an approved invoice.

FIG. 9 illustrates an example of another window of a graphical user interface (GUI) of the system described herein, showing different ways to pay an approved invoice.

FIG. 10 illustrates an example of another window of a graphical user interface (GUI) of the system described herein, showing different ways to pay an approved invoice.

FIG. 11 illustrates an example of another window of a graphical user interface (GUI) of the system described herein, illustrating an expanded approvals tab from FIG. 3.

FIG. 12 illustrates an example of another window of a graphical user interface (GUI) of the system described herein, illustrating an expanded disputed tab from FIG. 3.

FIG. 13 illustrates an example of another window of a graphical user interface (GUI) of the system described herein, illustrating a new dispute message.

FIG. 14 illustrates an example method according to the subject matter described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Traditionally, the process of receiving and preparing invoices, obtaining approvals, filing disputes, and entering invoices into various enterprise resource planning (ERP) tools is a tedious process. ERP tools are designed to manage and integrate a company's core business processes, such as financials, manufacturing, supply chain, project management, and human resources. Traditionally, however, there is no way to automatically receive an invoice into an ERP from an email. Traditionally, this process requires significant hours of human labor, and is extremely error prone. Accordingly, it would be advantageous to have a system and method that is able to automate the process of receiving and preparing invoices, obtaining approvals, filing disputes, and entering invoices into various ERP tools. Such a tool would save companies thousands of hours of human labor per year, inherently reducing the margin of human error and saving companies thousands of dollars per year.

The systems and methods described herein can address the aforementioned shortcomings. For example, one or more embodiments of the system herein can include a computing system designed receive files in a diverse variety of formats, convert the files into a format that is digestible for the system, determining relevant information for preparing a uniform invoice, and preparing an invoice in a format that is compatible with a variety of ERP tools.

One or more embodiments of the computing system can also include a database configured to store data characterizing a plurality of emails sent and received, a plurality of projects, a plurality of vendors, and a plurality of invoices. Each invoice can include data characterizing a project, a vendor, and a plurality of other invoice data. The database can be configured to organize the data stored thereon in an easily searchable way, and distribute data stored thereon to desired parties in an autonomous manner. Said computing system can automatically link email accounts to a variety of ERP tools. In some embodiments, the computing system described herein can scrape all attachments sent to the respective email accounts for relevant invoices, quotes, and/or financial agreements. In some embodiments, the computing system described herein can use optical character recognition (OCR) to transform the relevant data into a format that is digestible by the inventive interface and places it into the proper location.

The current subject matter can advantageously provide a system and method for automating and organizing accounts payable (NP) system for a business by extracting each bill directly from the source (i.e. email accounts), capturing the necessary fields, obtain all required approvals, and providing a uniform invoice appropriate location (i.e. it on the database and/or provide it to an ERP tool).

The description below references the figures and embodiments disclosed above. One of ordinary skill in the art should understand that such references are only exemplary in nature and are therefore not meant to be limiting. Part or all of the disclosed system, methods, and devices may be rearranged, combined, added to, and/or removed in a variety of manners, each of which is contemplated herein.

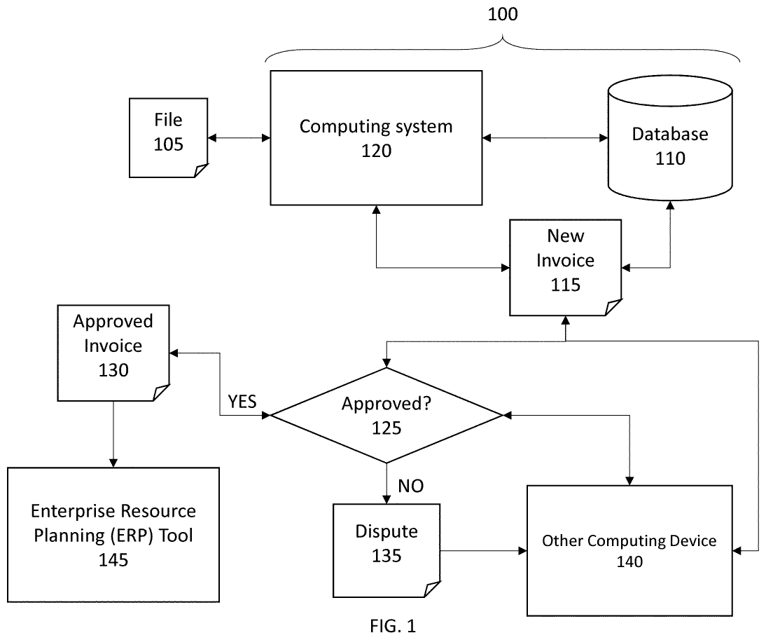

FIG. 1 is a flow diagram illustrating a process of converting a file 105 into a new invoice 115 and sending it to an ERP 145 using the system 100 including database 110 and computing system 120 upon being approved at 125. The flow diagram of FIG. 1 also illustrates the creating of a dispute 135 and the sending of the dispute 135 to one or more other computing devices 140. In some embodiments, the one or more other computing devices 140 can be a device similar to computing system 120. In other embodiments, the new invoice 115 can be sent to the one or more other computing devices 140 for approval 125. In some embodiments, the approved invoice 130 can be transmitted to the ERP 145 using an Application Programming Interface (API) integration/connector designed to connect the system 100 to the ERP 145. In some embodiments, the API can operate using Hypertext Transfer Protocol (HTTP) POST or HTTP PUT methods, or any other viable method thereof to communicate data between the system 100 and the ERP 145.

In some embodiments, the database 110 can be configured to store data characterizing a plurality of projects, a plurality of vendors, and a plurality of invoices, wherein each invoice includes data characterizing a project of the plurality of projects, a vendor of the plurality of vendors, and a plurality of other invoice data. In some embodiments, the other invoice data can include data characterizing, but not limited to, invoice numbers, invoice dates, total amounts, cost codes/categories, dates received, descriptions of work, notes, file names, digital fingerprints (i.e. hashes), financial data, customer data, product data, supplier data, change order data, and employee data.

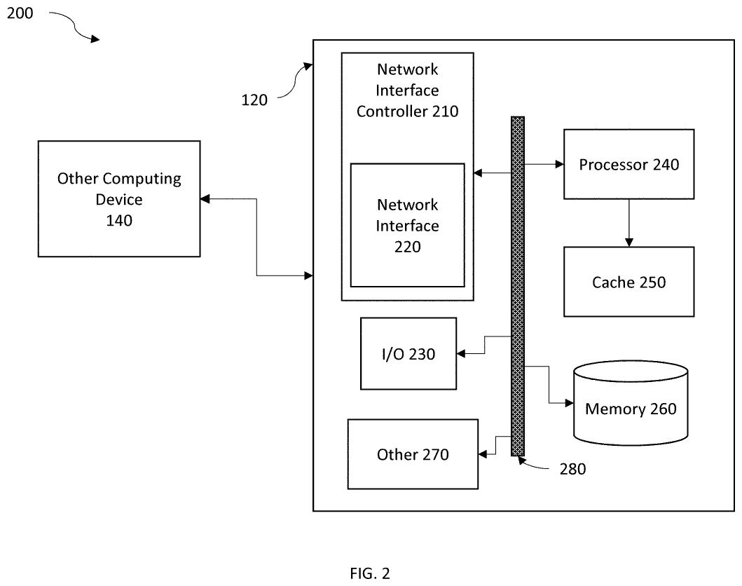

FIG. 2 is a block diagram of an example architecture 200 of a computing system or device, such as the computing system 120 configured to receive data from one or more other computing devices 140. In some embodiments the other computing devices 140 can be similar to the computing system 120. In broad overview, the computing system 120 can include at least one processor 240 for performing actions in accordance with instructions, and one or more memory devices 250 and/or 260 for storing instructions and data. The illustrated example computing system 120 includes one or more processors 240 in communication, via a bus 280, with memory 260 and with at least one network interface controller 210 with a network interface 220 for connecting to the other computing devices 140. The one or more processors 240 are also in communication, via the bus 280, with each other and with the plurality of other computing devices 140, and any other devices 270. The processor 240 illustrated incorporates, or is directly connected to, cache memory 250. Generally, a processor will execute instructions received from memory. In some embodiments, the computing system 120 can be configured within a cloud computing environment, a virtual or containerized computing environment, and/or a web-based microservices environment.

In more detail, the processor 240 can be any logic circuitry that processes instructions, e.g., instructions fetched from the memory 260 or cache 250. In many embodiments, the processor 240 is an embedded processor, a microprocessor unit or special purpose processor. The computing system 120 can be based on any processor, e.g., suitable digital signal processor (DSP), or set of processors, capable of operating as described herein. In some embodiments, the processor 240 can be a single core or multi-core processor. In some embodiments, the processor 240 can be composed of multiple processors.

The memory 260 can be any device suitable for storing computer readable data. The memory 260 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid state memory), magnetic disks, and magneto optical disks. A computing device 120 can have any number of memory devices 260.

The cache memory 250 is generally a form of high-speed computer memory placed in close proximity to the processor 240 for fast read/write times. In some implementations, the cache memory 250 is part of, or on the same chip as, the processor 240.

The network interface controller 210 manages data exchanges via the network interface 220. The network interface controller 210 handles the physical, media access control, and data link layers of the Open Systems Interconnect (OSI) model for network communication. In some implementations, some of the network interface controller's tasks are handled by the processor 240. In some implementations, the network interface controller 210 is part of the processor 240. In some implementations, a computing device 120 has multiple network interface controllers 210. In some implementations, the network interface 220 is a connection point for a physical network link, e.g., an RJ 45 connector. In some implementations, the network interface controller 210 supports wireless network connections via network interface port 220. Generally, a computing device 120 exchanges data with the other computing devices 140, via physical or wireless links to a network interface 220. In some implementations, the network interface controller 210 implements a network protocol such as LTE, TCP/IP Ethernet, IEEE 802.11, IEEE 802.16, or the like.

The other computing devices 140 can be connected to the computing device 120 via a network interface port 220. The other devices 270 can include an I/O interface 230, external serial device ports, and any additional co-processors. For example, a computing system 120 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 120, e.g., a touch screen on a tablet device. In some implementations, a computing device 120 includes an additional device 270 such as a co-processor, e.g., a math co-processor that can assist the processor 240 with high precision or complex calculations.

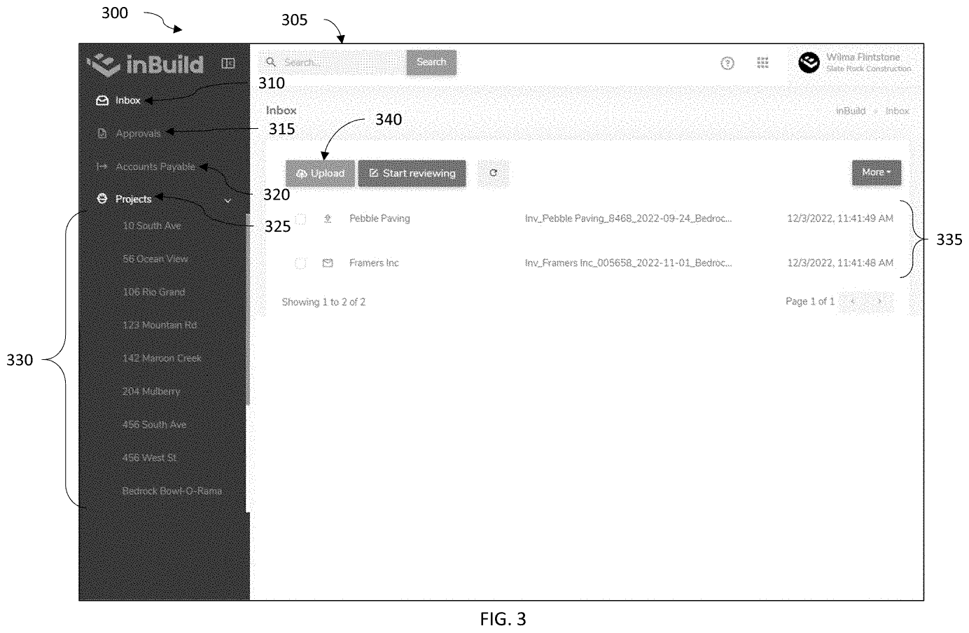

FIG. 3 illustrates an example of a graphical user interface (GUI) 300 of the system 100. In some embodiments, GUI 300 can include a first window 305, which can include an inbox tab 310, an approvals tab 315, an accounts payable tab 320, and a projects tab 325. In some embodiments, the projects tab 325 can open up into a plurality of projects 330. The inbox tab 310 can be configured to directly access a users' emails to extract every file attached to incoming emails. In some embodiments this can be done using an Internet Message Access Protocol (IMAP). Once extracted, a plurality of files 333 can be placed in a queue within the first window 305. In some embodiments the documents can be organized chronologically. In some embodiments, files can be alternatively be uploaded manually using an upload button 340. The computing system 120 can be configured to convert a first file of the plurality of files 335 in a first format into a second format. In some embodiments, the first format can be any type of image file, document file or presentation file. The first format can include, but is not limited to, a PDF, JPEG format, a Word® format, an Excel® format, a CSV format, and a Text format. In some embodiments, the second format can include the JPEG format.

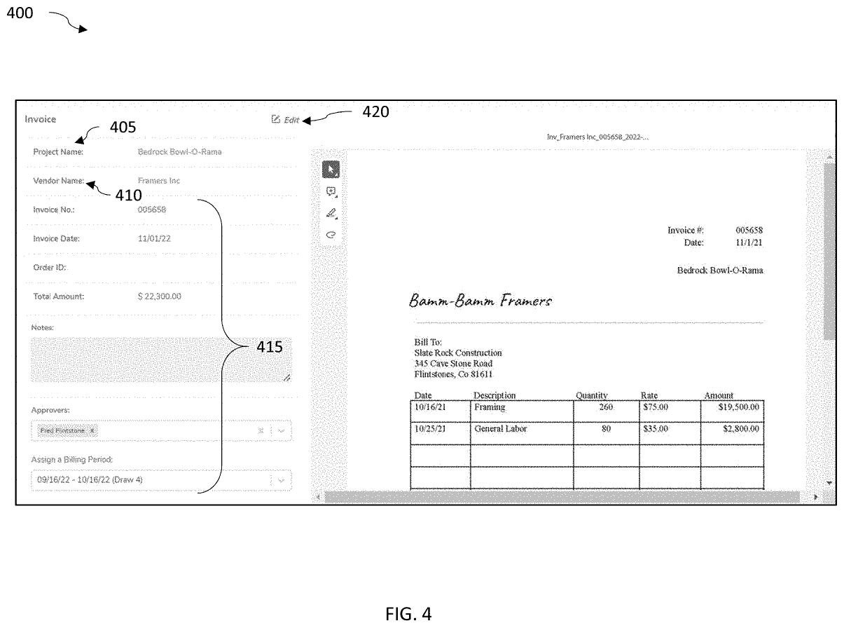

FIG. 4 is an example of a second window 400 of the GUI 300 showing a first project 405, a first vendor 410, and a first plurality of other invoice data 415 determined by the at least one processor 240 based on data in the file in the second format. In some embodiments, the first plurality of other invoice data 415 can include but are not limited to: Date Received, Time Received, Received From, Initial Document Name, Document Type, Vendor Name, Project Name, Project Number, Purchase Order, Contract Number, Invoice Number, Invoice Date, Cost Code Category, Cost Codes, Amount Due, and Billing Date. In some embodiments the determining can be done using optical character recognition (OCR). In some embodiments, the first project 405, the first vendor 410, and the first plurality of other invoice data 415 can be determined by cross-referencing data determined using the OCR with data stored in a database (i.e. database 110 of FIG. 1). In some embodiments, the second window 400 can include an edit button 420 to edit the first project 405, the first vendor 410, and/or first plurality of other invoice data 415 determined by the at least one processor 240. In some embodiments, the system 100 can include machine learning algorithms that are configured to use any edits made by a user to improve upon future outputs produced by the OCR tool. In some embodiments, the at least one processor can determine that the first project is not in the plurality of projects and/or that the first vendor is not in the plurality of vendors. In this situation, the at least one processor 240 can create a new project in the plurality of projects based on the first project and/or a new vendor of the plurality of vendors based on the first vendor. In another embodiment, the at least one processor 240 can prompt the user to create a new project and/or vendor manually.

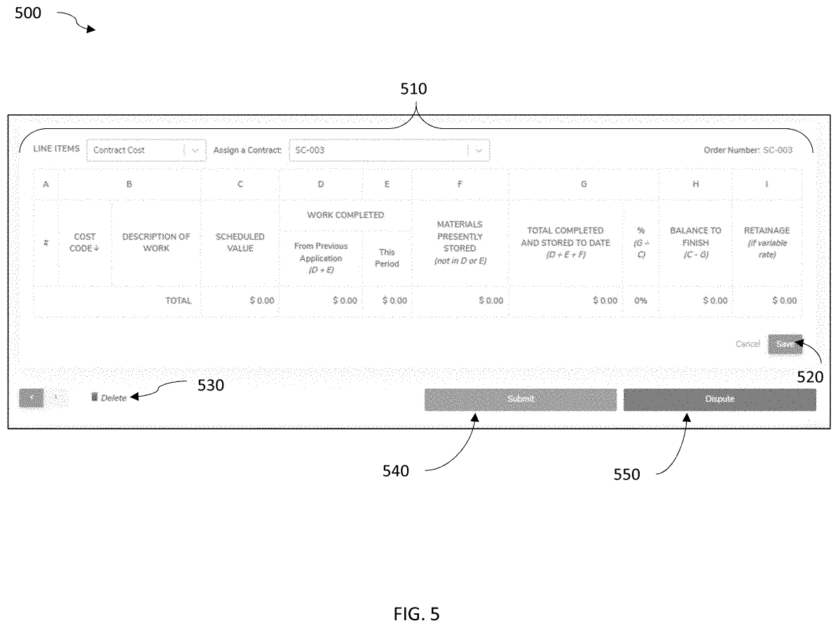

FIG. 5 is an example of a third window 500 of the GUI 300 showing a prepared a new invoice 510 based on the first project, the first vendor, and the first plurality of other invoice data determined. In some embodiments, the third window 500 can include can include a save button 520 to save the invoice for later submission. In some embodiments, the third window 500 can include a delete button 530 to delete the prepared invoice 510. In some embodiments, the third window 500 can include a submit button 540 to submit the prepared invoice 510 to an approver. In some embodiments this can be done via email. In some embodiments, the third window 500 can include a dispute button 550 to submit a dispute to a requestor. In some embodiments this can be done via email. In some embodiments, the user can add notes to the prepared invoice to save in the first plurality of other invoice data.

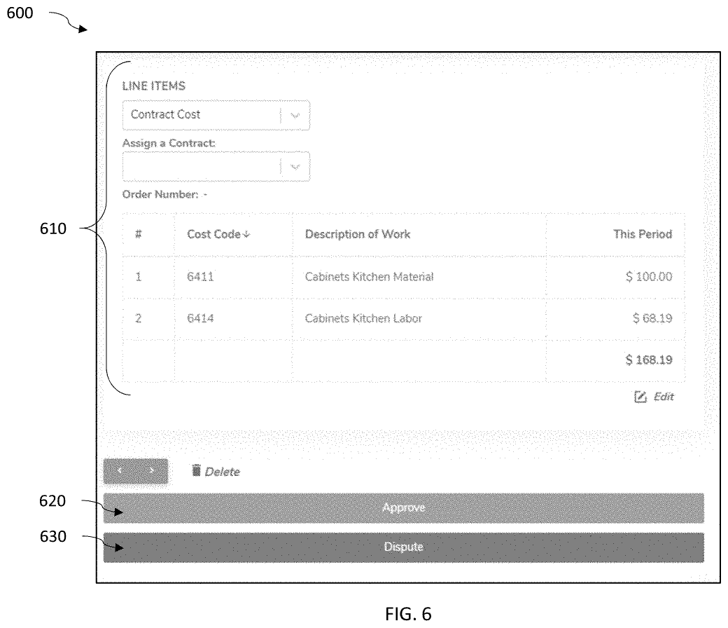

FIG. 6 is an example of a fourth window 600 of the GUI 300 showing a prepared a new invoice 610 received by a requestor to be approved an approver. In some embodiments, the approver can be a general contractor in the construction industry. In some embodiments the requestor can be an employee of the approver. In other embodiments, the requestor can be a separate entity (i.e. a requesting sub-contractor). The invoice 610 can include, but is not limited to, a cost type, an assigned contract, a plurality of line items, each including an order number, a description and/or a cost. In some embodiments the fourth window 600 can further include an approve button 620 and a dispute button 630. In some embodiments, when the invoice 610 is approved, it can be sent through an ERP application programming interface (API) to an ERP of the user's choosing.

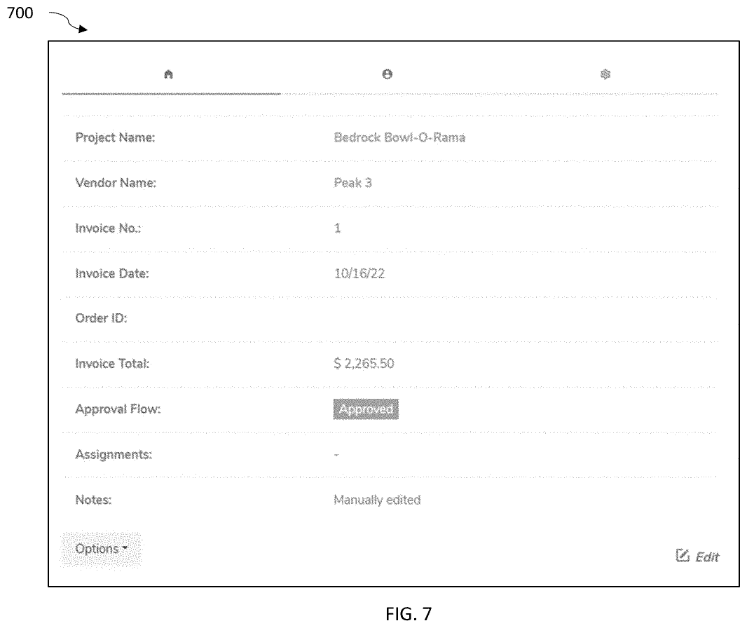

FIG. 7 is an example of a fifth window 700 of the GUI 300 showing an approved invoice.

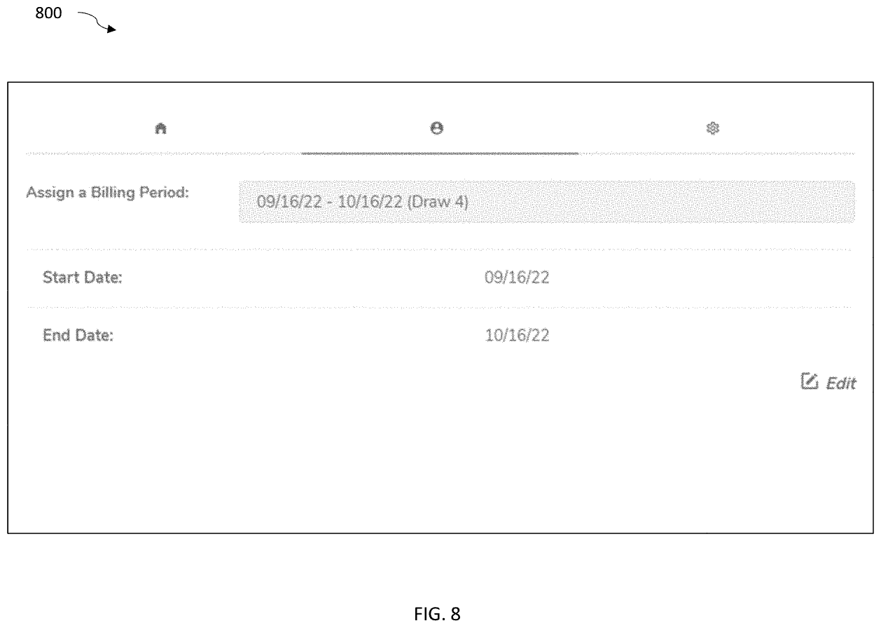

FIG. 8 is an example of a sixth window 800 of the GUI 300 showing an assigned billing period for an approved invoice.

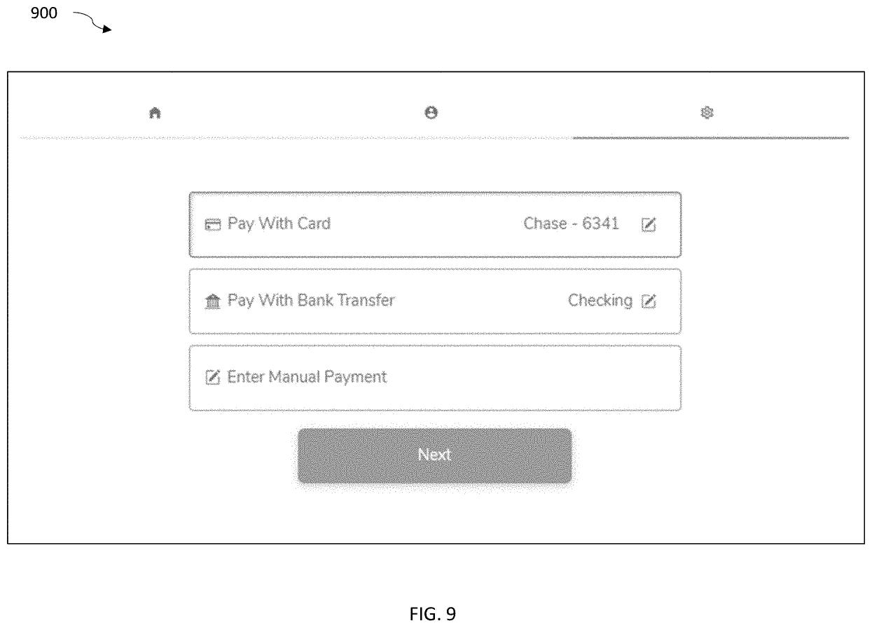

FIG. 9 is an example of a seventh window 900 of the GUI 300 showing different ways to pay an approved invoice. In some embodiments, the computing system 120 can be configured to pay an approved invoice directly using a credit or debit card, a bank transfer, a check, an automated clearing house (ACH) transfer, or any other viable form of electronic payment.

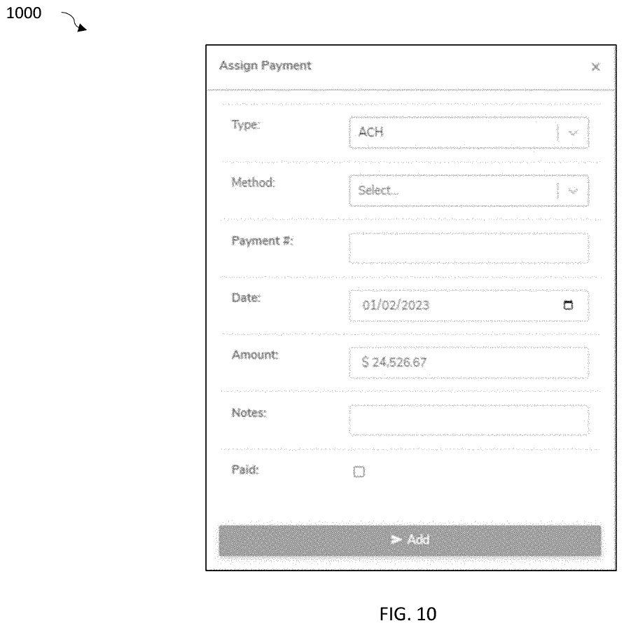

FIG. 10 is an example of an eighth window 1000 of the GUI 300 showing different ways to pay an approved invoice. In some embodiments, the computing system 120 can be configured to pay an approved invoice directly using a credit or debit card, a bank transfer, a check, an automated clearing house (ACH) transfer, or any other viable form of electronic payment.

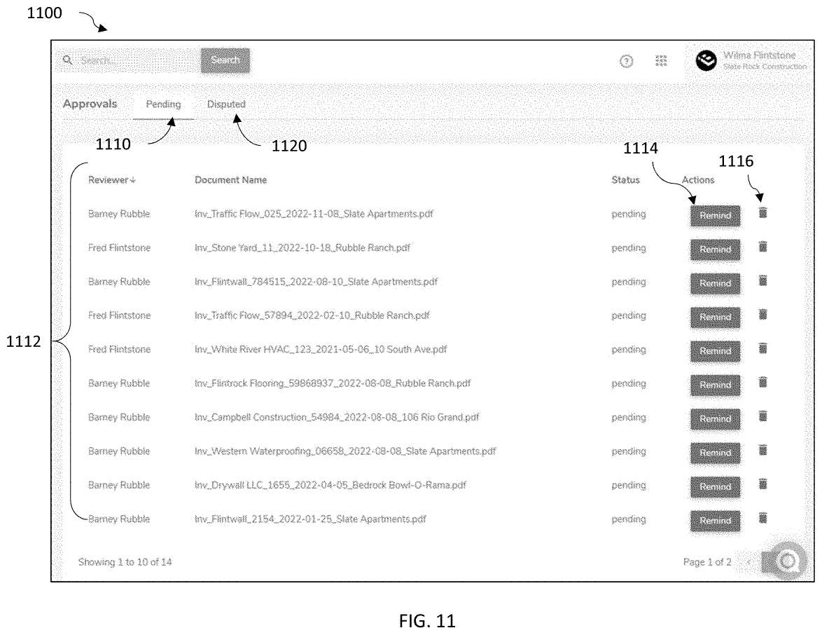

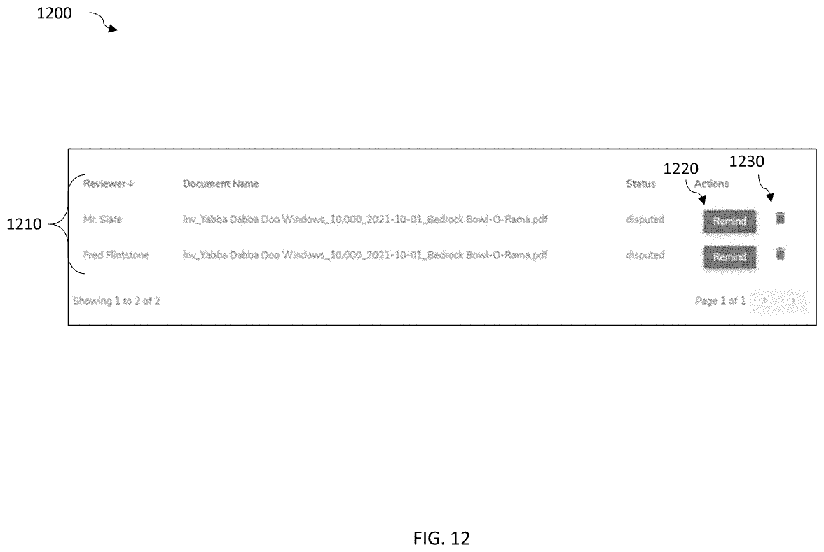

FIG. 11 is an example of a ninth window 1100 of the GUI 300 illustrating the expanded approvals tab 310 from FIG. 3. In some embodiments, the ninth window 1100 can further include the inbox tab 305, the approvals tab 310, the accounts payable tab 315, and the projects tab 320 as seen in FIG. 3. In some embodiments, the projects tab 320 open up into the plurality of projects 325. In some embodiments the ninth window 1100 can have a pending tab 1110 to show a list of pending approvals 1112. In some embodiments, the ninth window 1100 can have a disputed tab 1120 to show a list of disputed approvals (shown below in FIG. 12). In some embodiments, the ninth window 1100 can show the list 1112 organized chronologically. In some embodiments, each invoice in the list 1112 can include a remind button 1114 and/or a delete button 1116. The remind button 1112 can be used to send a reminder to the approver, and the delete button 1116 can be used to delete the pending invoice.

FIG. 12 is an example of a tenth window 1200 of the GUI 300 illustrating the expanded disputed tab 1120 of FIG. 11. In some embodiments, the tenth window 1200 can show the list 1210 organized chronologically. In some embodiments, each invoice in the list 1210 can include a remind button 1220 and/or a delete button 1230. The remind button 1220 can be used to send a reminder to the requestor, and the delete button 1230 can be used to delete the pending invoice.

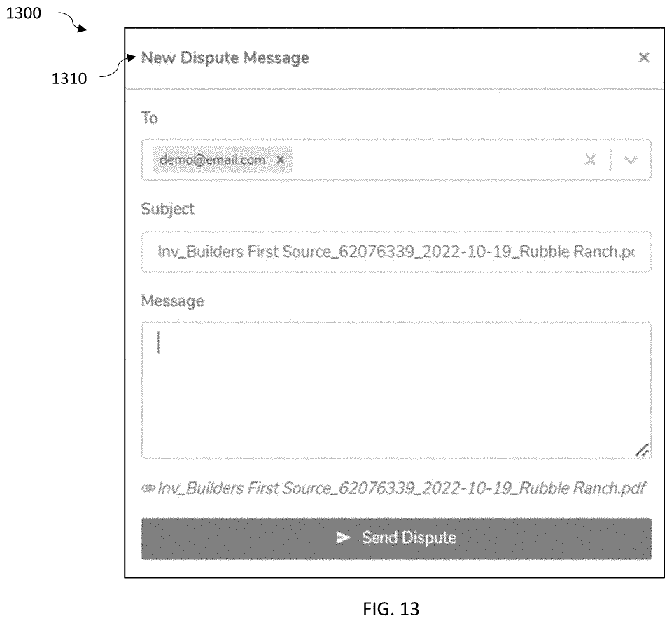

FIG. 13 is an example of an eleventh window 1300 of the GUI 300, illustrating a new dispute message 1310. In some embodiments the dispute message 1310 can be send automatically to an initial sender of the invoice. In some embodiments, the new dispute message 1310 can include a dispute message.

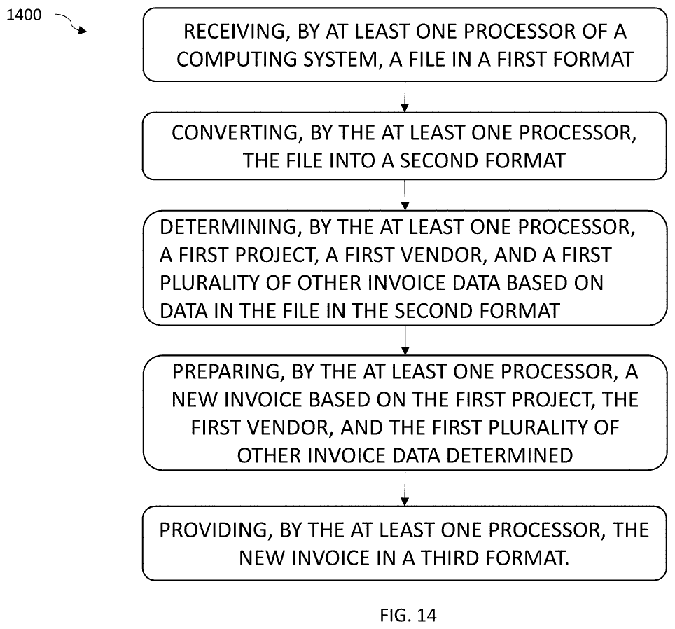

FIG. 14 illustrates an example method 1400. The method 1400 can include receiving, by at least one processor of a computing system, a file in a first format. In some embodiments, the first format can include, but is not limited to, a PDF, JPEG format, a Word® format, an Excel® format, a CSV format, a Text format, and a JSON format. In some embodiments, the file can be received by scraping it from an email attachment using an email scarping API.

The method 1400 can further include converting, by the at least one processor, the file into a second format. In some embodiments, the second format can include a JPEG format. In some embodiments, the file can be converted to the second format using an imaging editing software an image conversion library, or an online conversion service communicatively coupled to the system 100 (in reference to FIG. 1).

The method 1400 can further include determining, by the at least one processor, a first project, a first vendor, and a first plurality of other invoice data based on data in the file in the second format. In some embodiments, the determining can be done using OCR, image processing, and/or text generation. In some embodiments, the determining can further include comparing the first project, the first vendor, and the first plurality of other invoice data to data stored in the memory of the computing device 120 or in the database 110. The data stored in the memory of the computing device 120 or in the database 110 can include, for example, examples of similar documents, relevant data or information, and any specific instructions or guidelines for the content and structure of the document.

The method 1400 can further include preparing, by the at least one processor, a new invoice based on the first project, the first vendor, and the first plurality of other invoice data determined. In some embodiments, this can further include using one of a plurality of invoice templates stored in the memory of the computing device 120 or in the database 110, and populating the fields of the template with the proper data.

In some embodiments, the determining and preparing can further include using an artificial intelligence model that is configured to be trained using edits provided by a user throughout the method 1400. The artificial intelligence model can be configured to learn the patterns and features of the data that is relevant to the invoice.

The method 1400 can further include providing, by the at least one processor, the new invoice in a third format. In some embodiments the third format can be any one of a PDF a JSON format, and a CSV format. In some embodiments, the new invoice can be converted to the third format using a programming language to generate a PDF base on a predetermined PDF template and the first project, the first vendor, and the first plurality of other invoice data. In some embodiments, the new invoice can be converted to the third format using a document editing software, an PDF conversion/generation library, or an online conversion service communicatively coupled to the system 100 (in reference to FIG. 1).

The method 1400 can further include providing, by the at least one processor, the new invoice in a third format. In some embodiments, the step of providing can further include providing the new invoice to an ERP tool communicatively coupled to system 100. In some embodiments, the step of providing can further include providing the new invoice to an the database 110.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and serially-arranged by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be serially-arranged by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A system comprising:
a database configured to store data characterizing a plurality of projects, a plurality of vendors, and a plurality of invoices, wherein each invoice includes data characterizing a project of the plurality of projects, a vendor of the plurality of vendors, and a plurality of other invoice data; and
a computing system communicatively coupled to the database and including a memory and at least one processor configured to;
receive a file in a first format;
convert the file into a second format;
determine a first project, a first vendor, and a first plurality of other invoice data based on data in the file in the second format;
prepare a new invoice based on the first project, the first vendor, and the first plurality of other invoice data determined; and
provide the new invoice in a third format.

2. The system of claim 1, wherein the at least one processor is further configured to:
determine a name for the new invoice based on the first project, the first vendor, and/or first plurality of other invoice data determined, and based on instructions stored on the memory;
transmit the file and the new invoice to the database.

3. The system of claim 2, further comprising:
a graphical user interface (GUI) communicatively coupled to the computing system and configured to receive commands comprising a review command, an edit command, a validate command, an approve command, a dispute command, and/or a send command.

4. The system of claim 3, wherein system is further configured to:
receive, by the GUI, the dispute command; and
send, by the at least one processor, the new invoice to at least one email address along with an optional dispute message responsive to the received dispute command.

5. The system of claim 4, wherein the file is received as an attachment to an email message, and the first plurality of other invoice data further includes at least one requestor email address, wherein the at least one email address and the at least one requestor email address are the same.

6. The system of claim 3, wherein system is further configured to:
receive, by the GUI, the approve command; and
provide, by the at least one processor, the new invoice to an enterprise resource planning tool coupled to the computing system in the third format responsive to the received approve command.

7. The system of claim 1, wherein the first plurality of other invoice data further includes a first digital fingerprint for the file in the first format, and the database further includes data characterizing a plurality of digital fingerprints for a plurality of files in the first format, and the at least one processor is further configured to:
compare the first digital fingerprint to the data characterizing the plurality of digital fingerprints stored the database;
determine that the file is a duplicate based on the comparing; and
discard the file.

8. The system of claim 7, wherein the at least one processor is further configured to;
compare the first project, the first vendor, and/or first plurality of other invoice data to the data in stored the database.

9. The system of claim 1, wherein the at least one processor is further configured to:
compare the first project to the plurality of projects and/or the first vendor to the plurality of vendors;
determine that the first project is not in the plurality of projects and/or that the first vendor is not in the plurality of vendors; and
create a new project in the plurality of projects based on the first project and/or a new vendor of the plurality of vendors based on the first vendor.

10. The system of claim 1, wherein the determining of the first project, the first vendor, and the first plurality of other invoice data is done using optical character recognition.

11. The system of claim 1, wherein the first format is any one of an image format, a document format, and a presentation format, and the second format is an image format, and the third format is a document format.

12. A method comprising:
receiving, by at least one processor of a computing system, a file in a first format;
converting, by the at least one processor, the file into a second format;
determining, by the at least one processor, a first project, a first vendor, and a first plurality of other invoice data based on data in the file in the second format;
preparing, by the at least one processor, a new invoice based on the first project, the first vendor, and the first plurality of other invoice data determined; and
providing, by the at least one processor, the new invoice in a third format.

13. The method of claim 12, further comprising:
determining, by the at least one processor, a name for the new invoice based on the first plurality of other invoice data determined, and based on instructions stored on a memory of the computing system;
transmitting, by the at least one processor, the file and the new invoice to a database configured to store data characterizing a plurality of emails, a plurality of projects, a plurality of vendors, and a plurality of invoices, wherein each invoice includes data characterizing a project of the plurality of projects, a vendor of the plurality of vendors, and a plurality of other invoice data.

14. The method of claim 13, further comprising:
receiving, by the at least one processor, a dispute command from a graphical user interface (GUI) communicatively coupled to the computing system;
sending, by the at least one processor, the new invoice to at least one email address along with an optional dispute message responsive to receiving the dispute command.

15. The method of claim 14, wherein the file is received as an attachment to an email message, and the first plurality of other invoice data further includes at least one requestor email address, wherein the at least one email address and the at least one requestor email address are the same.

16. The method of claim 13, further comprising:
receiving, by the at least one processor, an approve command from a graphical user interface (GUI) communicatively coupled to the computing system;
providing, by the at least one processor, the new invoice to an enterprise resource planning tool coupled to the computing system responsive to receiving the approve command.

17. The method of claim 13, wherein the first plurality of other invoice data further includes a first digital fingerprint for the file in the first format, and the database further includes data characterizing a plurality of digital fingerprints for a plurality of files in the first format, the method further comprising:
comparing, by the at least one processor, the first digital fingerprint to the data characterizing the plurality of digital fingerprints stored the database;
determining, by the at least one processor, that the file is a duplicate based on the comparing; and
discarding the file, by the at least one processor.

18. The method of claim 17, wherein the comprising further comprises:
comparing, by the at least one processor, the first project, the first vendor, and/or first plurality of invoice data to the data in stored the database.

19. The method of claim 13, further comprising:
comparing, by the at least one processor, the first project to the plurality of projects and/or the first vendor to the plurality of vendors;
determining, by the at least one processor, that the first project is not in the plurality of projects and/or that the first vendor is not in the plurality of vendors; and
creating, by the at least one processor, a new project in the plurality of projects based on the first project and/or a new vendor of the plurality of vendors based on the first vendor.

20. The method of claim 12, wherein the determining of the first project, the first vendor, and the first plurality of other invoice data is done using optical character recognition.
